(19) United States
(12) Patent Application Publication
(10) Pub. No.: US 2021/0136400 A1
(43) Pub. Date: May 6, 2021

(54) METHOD AND APPARATUS OF MERGE MODE DERIVATION FOR VIDEO CODING

(71) Applicant: MEDIATEK INC., Hsin-Chu (TW)

(72) Inventors: Chun-Chia CHEN, Hsinchu City (TW); Chih-Wei HSU, Hsinchu City (TW); Yu-Wen HUANG, Taipei City (TW)

(21) Appl. No.: 16/464,338

(22) PCT Filed: Nov. 16, 2017
(86) PCT No.: PCT/CN2017/111229

§ 371 Date: May 28, 2019

Related U.S. Application Data
(60) Provisional application No. 62/427,198, filed on Nov. 29, 2016.

(51) Int. Cl. H04N 19/513

(52) U.S. Cl. CPC H04N 19/513

(57) ABSTRACT

A method and apparatus of video coding using Merge mode or Skip mode in a video coding system are disclosed. According to this method, a Merge or Skip candidate list is generated from multiple-type candidates comprising one or more sub-block TMVP-type (temporal motion vector prediction-type) candidates. The step of generating a Merge or Skip candidate list comprises a pruning process dependent on whether a current sub-block TMVP-type candidate being inserted, a previous sub-block TMVP-type candidate in the Merge or Skip candidate list, or both are “single block”. According to another method, a Merge or Skip candidate list is generated from multiple-type candidates including sub-block TMVP-type (temporal motion vector prediction-type) candidates, where the sub-block TMVP-type candidates comprise two or more first sub-block temporal MV predictors.

### CROSS REFERENCE TO RELATED APPLICATIONS

The present invention claims priority to U.S. Provisional Patent Application, Ser. No. 62/427,198, filed on Nov. 29, 2016. The U.S. Provisional patent application is hereby incorporated by reference in its entirety.

### FIELD OF INVENTION

The present invention relates to motion vector prediction for Merge and Skip modes. In particular, the present invention relates to sub-PU (prediction unit) level Merge or Skip candidate list derivation.

### BACKGROUND OF THE INVENTION

A new international video coding standard, named High Efficiency Video Coding (HEVC) has been developed based on a hybrid block-based motion-compensated transform coding architecture. The basic unit for compression is termed coding tree unit (CTU). Each CTU may contain one coding unit (CU) or recursively split into four smaller CUs until the predefined minimum CU size is reached. Each CU (also named leaf CU) contains one or multiple prediction units (PUs) and a tree of transform units (TUs).

Merge Mode

For each Inter PU, one or two motion vectors (MVs) are determined using motion estimation. In order to increase the coding efficiency of motion vector (MV) coding in HEVC, HEVC motion vector prediction (MVP) to encode MV predictively. In particular, HEVC supports the Skip and Merge modes for MVP coding. For Skip and Merge modes, a set of candidates are derived based on the motion information of spatially neighbouring blocks (spatial candidates) or a temporal co-located block (temporal candidate). When a PU is coded using the Skip or Merge mode, no motion information is signalled. Instead, only the index of the selected candidate is coded. For the Skip mode, the residual signal is forced to be zero and not coded. In other words, no information is signalled for the residuals. Each merged PU reuses the MV, prediction direction, and reference picture index of the selected candidate.

For Merge mode in HEVC, up to four spatial MV candidates are derived from neighbouring blocks A₀, A₁, B₀ and B₁, and one temporal MV candidate is derived from bottom-right block, T_{BR} or centre-block T_{CT} as shown in FIG. 1. For the temporal candidate, T_{BR} is used first. If T_{BR} is not available, T_{CT} is used instead. Note that if any of the four spatial MV candidates is not available, the block B₂ is then used to derive MV candidate as a replacement. After the derivation process of the four spatial MV candidates and one temporal MV candidate, removing redundancy (pruning) is applied to remove any redundant MV candidate. If after removing redundancy (pruning), the number of available MV candidates is smaller than five, three types of additional candidates are derived and are added to the candidate set (candidate list). The encoder selects one final candidate within the candidate set for Skip or Merge mode based on the rate-distortion optimization (RDO) decision, and transmits the index to the decoder.

Since the derivations of Skep and Merge candidates are similar, the “Merge” mode referred hereafter may correspond to “Merge” mode as well as “Skip” mode for convenience.

It is desirable to develop a Merge or Skip candidate list that can expand the candidate selection to cover another type of candidates, i.e., sub-PU temporal MVP candidates to improve coding performance.

### SUMMARY OF THE INVENTION

A method and apparatus of video coding using Merge mode or Skip mode in a video coding system are disclosed. According to this method, the current block is divided into current sub-blocks comprising a first current sub-block and a second current sub-block. Sub-block temporal MV (motion vector) predictors are generated by deriving motion information for collocated sub-block in one collocated picture corresponding to the current sub-blocks based on one sub-block temporal TMVP generation process, wherein the motion information comprises a motion vector and the motion vector is allowed to be different for different collocated sub-blocks. A Merge or Skip candidate list is generated from multiple-type candidates comprising one or more sub-block TMVP-type (temporal motion vector prediction-type) candidates. The step of generating a Merge or Skip candidate list comprises a pruning process dependent on whether a current sub-block TMVP-type candidate being inserted, a previous sub-block TMVP-type candidate in the Merge or Skip candidate list, or both are “single block”. A sub-block TMVP-type candidate is determined to be “single block” if motion information of all sub-blocks inside a block including said the sub-block TMVP-type candidate is the same, where the motion information of all sub-blocks is derived based on one sub-block temporal TMVP generation process. The current motion vector of the current block is encoded or decoded in the Merge mode or Skip mode according to the Merge or Skip candidate list.

According to this this method, when a current sub-block TMVP-type candidate is being inserted into the Merge or Skip candidate list and the current sub-block TMVP-type candidate is “single block”, if motion information of the current sub-block TMVP-type candidate is the same as motion information of any whole-block candidate in the Merge or Skip candidate list or motion information of any other sub-block TMVP-type candidate being “single block” in the Merge or Skip candidate list, then the current sub-block TMVP-type candidate is pruned by being not inserted into the Merge or Skip candidate list. In another example, when a current whole block candidate is being inserted into the Merge or Skip candidate list, if motion information of the current whole block candidate is the same as motion information of any other whole block candidate already in the Merge or Skip candidate list or motion information of any sub-block TMVP-type candidate being “single block” in the Merge or Skip candidate list, then the current whole block candidate is pruned by being not inserted into the Merge or Skip candidate list.

A method and apparatus of video coding using Merge mode or Skip mode in a video coding system are disclosed. According to this method, the current block is divided into current sub-blocks. First sub-block temporal MV (motion vector) predictors are generated by deriving motion information for collocated sub-block in one collocated picture corresponding to the current sub-blocks according to a first sub-block temporal TMVP (temporal motion vector prediction) generation process. The motion information comprises a motion vector and the motion vector is allowed to be different for different collocated sub-blocks. A Merge or Skip candidate list is generated from multiple-type candidates including sub-block TMVP-type (temporal motion vector prediction-type) candidates, where the sub-block TMVP-type candidates comprise two or more first sub-block temporal MV predictors. The current motion vector of the current block is encoded or decoded in the Merge mode or Skip mode according to the Merge or Skip candidate list.

Each block may correspond to one prediction unit (PU). In one embodiment, if motion vectors associated with two first sub-block temporal MV predictors are different, the two first sub-block temporal MV predictors are inserted into the Merge or Skip candidate list. In one embodiment, the Merge or Skip candidate list includes two or more sub-block TMVP-type candidates. The collocated pictures in reference picture list 0 or reference picture list 1 for collocated sub-blocks may be different. In another embodiment, only one collocated picture in reference picture list 0 or reference picture list 1 exists for all collocated sub-blocks. The motion information may further comprise reference picture list, reference picture index, and local illumination compensation flag.

In one embodiment, when a current sub-block TMVP-type candidate is being inserted into the Merge or Skip candidate list and the current sub-block TMVP-type candidate is “single block”, if motion information of the current sub-block TMVP-type candidate is also the same as motion information of any whole-block candidate in the Merge or Skip candidate list or motion information of any other sub-block TMVP-type candidate in the Merge or Skip candidate list being “single block”, then the current sub-block TMVP-type candidate is pruned by being not inserted into the Merge or Skip candidate list.

In another embodiment, when a current whole block candidate is being inserted into the Merge or Skip candidate list, if motion information of the current whole block candidate is the same as motion information of any other whole block candidate already in the Merge or Skip candidate list or motion information of any sub-block TMVP-type candidate in the Merge or Skip candidate list being “single block”, then the current whole block candidate is pruned by being not inserted into the Merge or Skip candidate list.

In yet another embodiment, second sub-block temporal MV predictors are further generated by deriving the motion information for collocated sub-block in one collocated picture corresponding to the current sub-blocks according to a second sub-block temporal TMVP generation process. One or more second sub-block temporal MV predictors are then included in the sub-block TMVP-type candidates for generating the Merge or Skip candidate list.

### BRIEF DESCRIPTION OF THE DRAWINGS

FIG. 1 illustrates the spatial neighbouring blocks and collocated temporal block used to generate the Skip or Merge candidate list according to the HEVC (high efficiency video coding) standard.

FIG. 2 illustrates an exemplary sub-PU temporal motion vector prediction (sub-PU TMVP) derivation.

FIG. 3 illustrates exemplary pseudo codes to determine whether the motion information for all sub-PUs is the same. If the motion information for all sub-PUs is the same, the sub-PUs are designated as “single block” and the motion information for all sub-PUs is set to SubPU_MI_0.

FIG. 4 illustrates exemplary pseudo codes to generate a Merge or Skip candidate list using predictors including sub-PU TMVP according to an embodiment of the present invention.

FIG. 5 illustrates an exemplary flowchart of video coding system incorporate an embodiment of the present invention, where a pruning process is dependent on whether a current sub-block TMVP-type candidate being inserted, a previous sub-block TMVP-type candidate in the Merge or Skip candidate list, or both are “single block”.

FIG. 6 illustrates an exemplary flowchart of video coding system incorporate an embodiment of the present invention, where sub-PU temporal MV predictors are derived and the Merge or Skip candidate list is generated by using predictors including sub-PU TMVP.

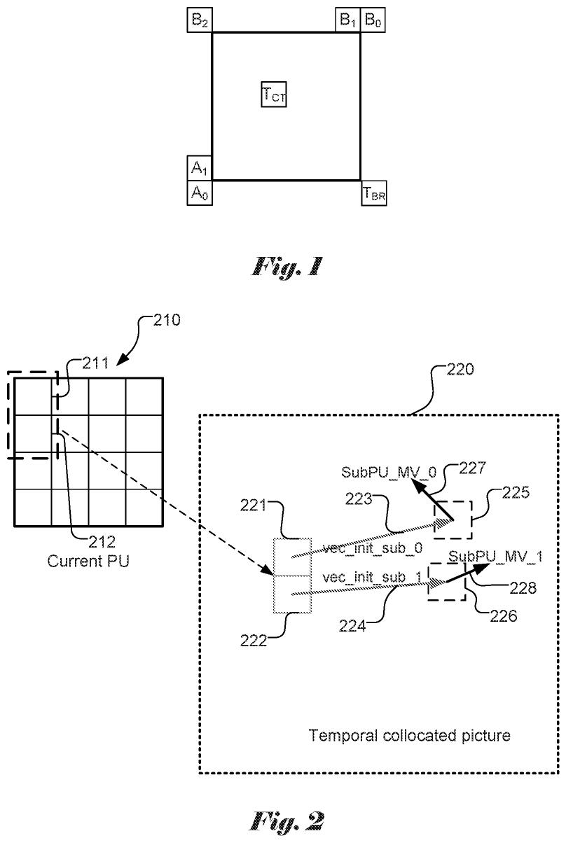

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

Expanded Sub-PU Temporal Motion Vector Prediction (Sub-PU TMVP)

In order to improve the coding efficiency, a sub-PU Temporal Motion Vector Prediction (sub-PU TMVP) mode has been applied in the Merge mode. The present invention discloses method to expand the sub-PU TMVP, please note that sub-PU may also be referred as sub-block in this disclosure. According to the conventional sub-PU TMVP, the temporal MV predictor associated with a sub-PU is derived and used as a Merge candidate for Merge mode. However, according to the conventional sub-PU TMVP, all sub-PUs have the same initial motion vector. Essentially, all the sub-PUs are treated as a “single block”.

FIG. 2 illustrates an example of sub-PU TMVP derivation according to the present invention. The current PU is partitioned into multiple sub-PUs and all corresponding temporal collocated motion vectors for each Sub-PU are determined according to the present sub-PU TMVP mode. For a current PU of size M×N, the PU can be partitioned into (M/P)×(N/Q) sub-PUs and each sub-PU is of size P×Q, where M is divisible by P and N is divisible by Q. The example in FIG. 2 corresponds to the case that a current PU 210 is divided into 16 sub-PUs (i.e., M/P=4 and N/Q=4). Sub-PU 0 (211) and sub-PU 1 (212) are indicated. The detailed algorithm for sub-PU TMVP is described as follows.

In step 1, for the current PU 210, an “initial motion vector”, denoted it as vec_init is determined for the sub-PU TMVP mode. For example, the vec_init can be the MV of the first available spatial neighbouring block of the current PU 210. Alternatively, the MV of other neighbouring block may also be used as the initial motion vector.

In step 2, for each sub-PU, an “initial motion vector for each sub-PU”, denoted as vec_init_sub_i, where i=0, . . . , ((M/P)×(N/Q)−1)), is determined. For the conventional sub-PU TMVP, all vec_init_sub_i are set equal to vec_init for all i. For the present invention, the vec_init_sub_i is allowed to be different for different sub-PU (i.e., different i). In FIG. 2, picture 220 corresponds to a collocated picture. The locations of the current sub-PU 0 (221) and current sub-PU 1 (222) in the collocated picture are indicated. The initial motion vectors vec_init_sub_0 (223) and vec_init_sub_1 (224) for the current sub-PU 0 (221) and current sub-PU 1 (222) are indicated.

In step 3, for each sub-PU, a collocated picture for reference list 0 and a collocated picture for reference list 1 are determined. In one embodiment, there is only one collocated picture in reference list 0 for all sub-PUs of the current PU. In another embodiment, collocated pictures in reference list 0 are different for all sub-PUs. Similarly, in one embodiment, there is only one collocated picture in reference list 1 for all sub-PUs of the current PU. In another embodiment, collocated pictures in reference list 1 are different for all sub-PUs. The collocated picture in reference list 0 for sub-PU i can be denoted as collocated_picture_i_L0, and the collocated picture in reference list 1 for sub-PU i can be denoted as collocated_picture_i_L1.

In step 4, the collocated location in collocated picture for each sub-PU is determined. We assume that the current sub-PU is sub-PU i, the collocated location is calculated as follows:

collocated location x=Sub-PU_i_x+vec_init_sub_i_x(integer part)+shift_x,

collocated location y=Sub-PU_i_y+vec_init_sub_i_y(integer part)+shift_y.

In the above equations, Sub-PU_i_x means horizontal coordinate of the upper-left location of sub-PU i inside the current picture (integer location), and Sub-PU_i_y means vertical coordinate of the left-top location of sub-PU i inside the current picture (integer location). Furthermore, vec_init_sub_i_x means horizontal component of vec_init_sub_i, which has integer part and fractional part and however, only the integer part is used in the above calculation. Similarly, vec_init_sub_i_y means vertical part of vec_init_sub_i, which has integer part and fractional part and however, only the integer part is used in the above calculation. shift_x means an x shift value. For example, shift_x can be half of sub-PU width. However, other x shift value may be used. shift_y means a y shift value. For example, shift_y can be half of sub-PU height. However, other y shift value may be used. In FIG. 2, the collocated location (225) for sub-PU 0 and the collocated location (226) for sub-PU 1 are indicated.

Finally, in step 5, it finds the motion information temporal predictor for each sub-PU, denoted as SubPU_MI_i for sub-PU i. The SubPU_MI_i is the motion information from collocated_picture_i_L0 and collocated_picture_i_L1 at (collocated location x, collocated location y). The motion information (MI) is defined as the set of {MV_x, MV_y, reference lists, reference index, and other merge-mode-sensitive information, such as local illumination compensation flag}. Moreover, in one embodiment, MV_x and MV_y may be scaled according to the temporal distance relation between collocated picture, current picture, and reference picture of the collocated MV. In FIG. 2, MV part (i.e., SubPU_MV_i) of SubPU_MI_i is shown for sub-PU 0 (i.e., SubPU_MV_0 227) and sub-PU1 (i.e., SubPU_MV_1 228). The process to derive SubPU_MI_i for all sub-PUs inside the PU is referred as sub-block temporal MVP generation process in this disclosure. The SubPU_MV_i derived is referred as a sub-block temporal MV (motion vector) predictor in this disclosure.

Sub-PU TMVP “Single Block” Pruning for Merge Mode

In Merge mode of video coding, the sub-PU TMVP (also referred as sub-block TMVP) is treated as a Merge candidate in the Merge candidate list. For example, the Merge candidate list may consist of {S1, S2, S3, S4, sub-PU TMVP, S5, T}, where Si, i=1, . . . , 5, is a spatial candidate and T is a temporal candidate. In another example, the Merge candidate list may consist of {S1, S2, sub-PU TMVP1, S4, sub-PU TMVP2, S5, T}, where two sub-PU TMVPs are used. Traditionally, for normal candidates (i.e., non-Sub-PU candidates), one candidate can be pruned (i.e., removed from the candidate list) if the motion information (MI) of the current candidate is the same as another candidate. However, in order to improve the coding efficiency, a normal candidate can be replaced by the sub-PU TMVP in the pruning process according to an embodiment of the present invention. On the other hand, sub-PU TMVP can be replaced by a normal candidate during the pruning process.

In order to describe the above method, three types of candidates are defined. “Whole PU candidate” is defined as any candidate for a whole PU or a whole block (i.e., without Sub-PU/Sub-block partition). In this disclosure, “sub-PU TMVP candidate” is defined as any sub-PU TMVP. As illustrated in the second example above, there may be more than one sub-PU TMVP candidate in the Merge candidate list of the current PU since those sub-PU TMVP candidates can be different due to different sub-PU TMVP derivation process may be used. For example, a positive offset can be added to the initial motion vector according to one sub-PU TMVP derivation process. In another sub-PU TMVP derivation process, a negative offset may be added to the initial motion vector. Accordingly, first motion information can be derived for all sub-PUs using a first initial motion vector and second motion information can be derived for all sub-PUs using a second initial motion vector. “Alternative candidate” is defined as any candidate not belonging to “Whole PU candidates” and “sub-PU TMVP candidate”.

An embodiment according to the present invention, whether any sub-PU TMVP candidate should be marked as “single block” is checked. To check this, for sub-PU TMVP j, j=0, . . . , ((number of sub-PU TMVP candidates)−1), whether all SubPU_MI_i (i=0, . . . , (number of sub-PUs in current PU)−1) for the current sub-PU TMVP j are the same is checked. If all SubPU_MI_i (i=0, . . . , (number of sub-PUs in the current PU)−1) are the same, SubPU_MI_i for the current sub-PU TMVP j are denoted as subPU_same_mi. Furthermore, the sub-PU TMVP j is marked as “single block”. In this case, while sub-PU TMVP j is used for the sub-PUs of the PU, these sub-PUs have the effect of a “Whole PU candidate”. In the determination of “single block”, the sub-PUs are inside the same PU as sub-PU TMVP j. Also, a same sub-block temporal TMVP generation process is used for deriving the motion information of all sub-PUs.

The candidates are then inserted into the candidate list. During the candidate insertion, if the current inserted candidate is a sub-PU TMVP candidate, whether the current sub-PU TMVP is marked as “single block” is checked. If it is marked as “single block”, the subPU_same_mi of this sub-PU TMVP is compared with the MI of all “Whole PU candidate” and the MI of all other sub-PU TMVP candidate marked as “single block” in the candidate list. If the subPU_same_mi is equal to the MI of any “Whole PU candidate” or the MI of any other sub-PU TMVP candidate marked as “single block” in the candidate list, the current sub-PU TMVP i is pruned (i.e., not inserted into the candidate list).

During the candidate insertion, if the current inserted candidate is a Whole PU candidate, then the MI of the current inserted candidate is compared with the MI of all other “Whole PU candidate” and the MI of all sub-PU TMVP candidate marked as “single block” in the current candidate list. If the MI of the current inserted candidate is equal to the MI of any “Whole PU candidate” or the MI of any sub-PU TMVP candidate marked as “single block” in the current candidate list, the current inserted candidate is pruned (i.e., not inserted into the candidate list).

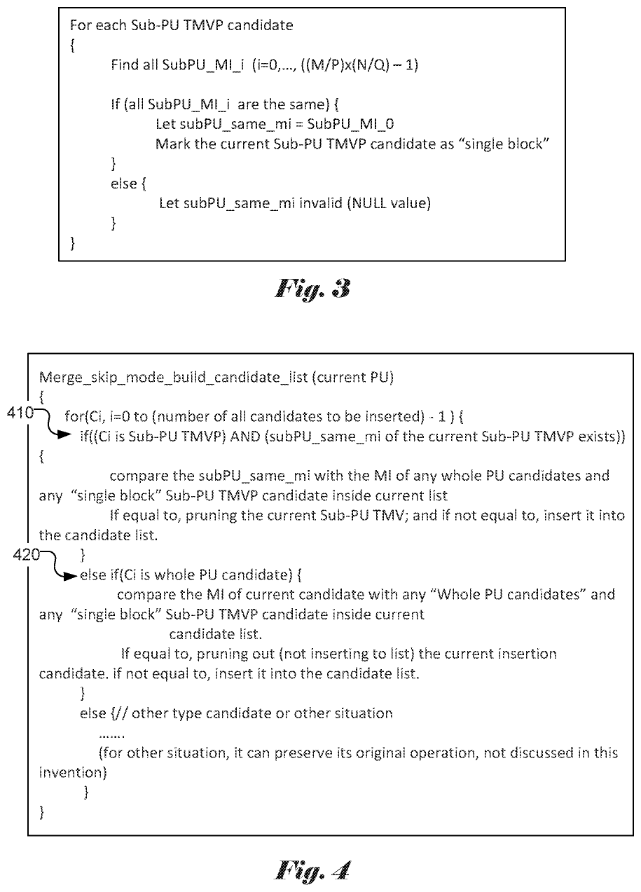

Exemplary pseudo codes of the above algorithm are shown in FIG. 3 and FIG. 4. The exemplary pseudo codes in FIG. 3 illustrate a process to check whether the sub-PU TMVP candidates are classified as a “single block”. In particular, if the statement, “If (all SubPU_MI_i are the same)” is true, the parameter subPU_same_mi is set to the first SubPU_MI_i (i.e., SubPU_MI_0) and the current sub-PU TMVP candidate is marked as “single block”. Otherwise (i.e., not all SubPU_MI_i being the same), subPU_same_mi is set to be invalid.

FIG. 4 shows an exemplary candidate list generation with pruning process involved with the sub-PU TMVP. The statement 410 is for the case that the current candidate (i.e., Ci) is sub-PU TMVP and subPU_same_mi of the current sub-PU TMVP exists. In this case, the subPU_same_mi is compared with the MI of all whole PU candidates and MI of all “single block” sub-PU TMVP candidates in current list. If it is equal, the current sub-PU TMVP is pruned (i.e., not inserted into the candidate list). Otherwise, the current sub-PU TMVP is inserted into the candidate list. If the statement 410 is not true, the process further checks whether the current inserted candidate is a Whole PU candidate in statement 420. If the current candidate is a Whole PU candidate, the MI of current candidate is compared with the MI of all “Whole PU candidates” and the MI of all “single block” sub-PU TMVP candidate in the current candidate list. If the result is true, the current candidate is pruned (i.e., not inserted into the candidate list). Otherwise, the current candidate is inserted into the candidate list. If statement 420 is not true, it implies the current candidate belongs to other types.

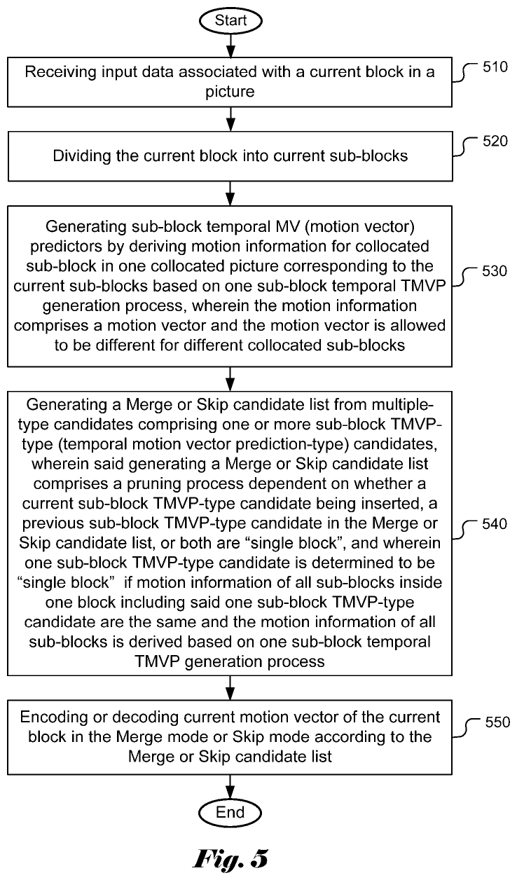

FIG. 5 illustrates an exemplary flowchart of video coding system incorporate an embodiment of the present invention, where a pruning process is dependent on whether a current sub-block TMVP-type candidate being inserted, a previous sub-block TMVP-type candidate in the Merge or Skip candidate list, or both are “single block”. The steps shown in the flowchart, as well as other flowcharts in this disclosure, may be implemented as program codes executable on one or more processors (e.g., one or more CPUs) at the encoder side and/or the decoder side. The steps shown in the flowchart may also be implemented based on hardware such as one or more electronic devices or processors arranged to perform the steps in the flowchart. According to this method, input data associated with a current block in a picture are received in step 510. The current block is divided into current sub-blocks in step 520. Sub-block temporal MV (motion vector) predictors are generated by deriving motion information for collocated sub-block in one collocated picture corresponding to the current sub-blocks based on one sub-block temporal TMVP generation process in step 530, wherein the motion information comprises a motion vector and the motion vector is allowed to be different for different collocated sub-blocks. A Merge or Skip candidate list generated from multiple-type candidates comprising one or more sub-block TMVP-type (temporal motion vector prediction-type) candidates in step 540, wherein said generating a Merge or Skip candidate list comprises a pruning process dependent on whether a current sub-block TMVP-type candidate being inserted, a previous sub-block TMVP-type candidate in the Merge or Skip candidate list, or both are “single block”, and wherein one sub-block TMVP-type candidate is determined to be “single block” if motion information of all sub-blocks inside one block including said one sub-block TMVP-type candidate is the same, and wherein the motion information of all sub-blocks is derived based on one sub-block temporal TMVP generation process. In step 550, the current motion vector of the current block is encoded or decoded in the Merge mode or Skip mode according to the Merge or Skip candidate list.

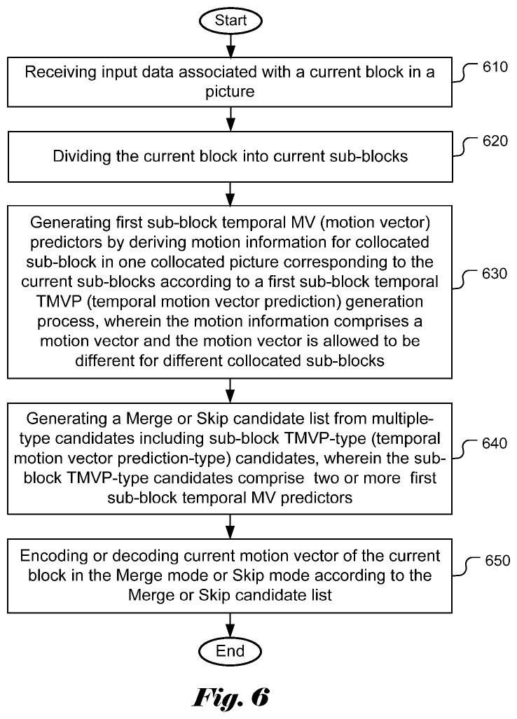

FIG. 6 illustrates an exemplary flowchart of video coding system incorporate an embodiment of the present invention, where sub-PU temporal MV predictors are derived and the Merge or Skip candidate list is generated by using predictors including sub-PU TMVP. According to this method, input data associated with a current block in a picture are received in step 610. The current block is divided into current sub-blocks in step 620. First sub-block temporal MV (motion vector) predictors are generated by deriving motion information for collocated sub-block in one collocated picture corresponding to the current sub-blocks according to a first sub-block temporal TMVP (temporal motion vector prediction) generation process in step 630, wherein the motion information comprises a motion vector and the motion vector is allowed to be different for different collocated sub-blocks. A Merge or Skip candidate list is generated from multiple-type candidates including sub-block TMVP-type (temporal motion vector prediction-type) candidates in step 640, wherein the sub-block TMVP-type candidates comprise two or more first sub-block temporal MV predictors. In step 650, the current motion vector of the current block is encoded or decoded in the Merge mode or Skip mode according to the Merge or Skip candidate list.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1.-4. (canceled)

5. A method of video coding using Merge mode or Skip mode in a video coding system, the method comprising:
receiving input data associated with a current block in a picture;
dividing the current block into current sub-blocks;
generating first sub-block temporal MV (motion vector) predictors by deriving motion information for collocated sub-block in one collocated picture corresponding to the current sub-blocks according to a first sub-block temporal TMVP (temporal motion vector prediction) generation process, wherein the motion information comprises a motion vector and the motion vector is allowed to be different for different collocated sub-blocks;
generating a Merge or Skip candidate list from multiple-type candidates including sub-block TMVP-type (temporal motion vector prediction-type) candidates, wherein the sub-block TMVP-type candidates comprise two or more first sub-block temporal MV predictors; and
encoding or decoding current motion vector of the current block in the Merge mode or Skip mode according to the Merge or Skip candidate list.

6. The method of claim 5, wherein each block corresponds to one prediction unit (PU).

7. The method of claim 5, wherein if motion vectors associated with two first sub-block temporal MV predictors are different, said two first sub-block temporal MV predictors are inserted into the Merge or Skip candidate list.

8. The method of claim 5, wherein the Merge or Skip candidate list includes two or more sub-block TMVP-type candidates.

9. The method of claim 5, wherein collocated pictures in reference picture list 0 or reference picture list 1 for collocated sub-blocks are different.

10. The method of claim 5, wherein only one collocated picture in reference picture list 0 or reference picture list 1 exists for all collocated sub-blocks.

11. The method of claim 5, wherein the motion information further comprises reference picture list, reference picture index, and local illumination compensation flag.

12. The method of claim 5, wherein when a current sub-block TMVP-type candidate is being inserted into the Merge or Skip candidate list and the current sub-block TMVP-type candidate is “single block”, if motion information of the current sub-block TMVP-type candidate is also the same as motion information of any whole-block candidate in the Merge or Skip candidate list or motion information of any other sub-block TMVP-type candidate in the Merge or Skip candidate list being “single block”, then the current sub-block TMVP-type candidate is pruned by being not inserted into the Merge or Skip candidate list; and wherein one sub-block TMVP-type candidate is determined to be “single block” if motion information of all sub-blocks inside one block including said one sub-block TMVP-type candidate are the same and the motion information of all sub-blocks is derived based on one sub-block temporal TMVP generation process.

13. The method of claim 5, wherein when a current whole block candidate is being inserted into the Merge or Skip candidate list, if motion information of the current whole block candidate is the same as motion information of any other whole block candidate already in the Merge or Skip candidate list or motion information of any sub-block TMVP-type candidate in the Merge or Skip candidate list being “single block”, then the current whole block candidate is pruned by being not inserted into the Merge or Skip candidate list; and wherein one sub-block TMVP-type candidate is determined to be “single block” if motion information of all sub-blocks inside one block including said one sub-block TMVP-type candidate are the same and the motion information of all sub-blocks is derived based on one sub-block temporal TMVP generation process.

14. The method of claim 5, further comprising generating second sub-block temporal MV predictors by deriving the motion information for collocated sub-block in one collocated picture corresponding to the current sub-blocks according to a second sub-block temporal TMVP generation process, wherein the sub-block TMVP-type candidates comprise one or more second sub-block temporal MV predictors.

15. An apparatus of video coding using Merge mode or Skip mode in a video coding system, the apparatus comprising one or more electronic devices or processors configured to:
receive input data associated with a current block in a picture;
divide the current block into current sub-blocks;
generate first sub-block temporal MV (motion vector) predictors by deriving motion information for collocated sub-block in one collocated picture corresponding to the current sub-blocks according to a first sub-block temporal TMVP (temporal motion vector prediction) generation process, wherein the motion information comprises a motion vector and the motion vector is allowed to be different for different collocated sub-blocks;
generate a Merge or Skip candidate list from multiple-type candidates including sub-block TMVP-type (temporal motion vector prediction-type) candidates, wherein the sub-block TMVP-type candidates comprise two or more first sub-block temporal MV predictors; and
encode or decode current motion vector of the current block in the Merge mode or Skip mode according to the Merge or Skip candidate list.

16. The apparatus of claim 15, wherein each block corresponds to one prediction unit (PU).

17. The apparatus of claim 15, wherein if motion vectors associated with two first sub-block temporal MV predictors are different, said two first sub-block temporal MV predictors are inserted into the Merge or Skip candidate list.

18. The apparatus of claim 15, wherein the Merge or Skip candidate list includes two or more sub-block TMVP-type candidates.

19. The apparatus of claim 15, said one or more electronic devices or processors are configured to further generate second sub-block temporal MV predictors by deriving the motion information for collocated sub-block in one collocated picture corresponding to the current sub-blocks according to a second sub-block temporal TMVP generation process, wherein the sub-block TMVP-type candidates comprise one or more second sub-block temporal MV predictors.
